(19) United States
(12) Patent Application Publication
(10) Pub. No.: US 2025/0148767 A1
(43) Pub. Date: May 8, 2025

(54) TRAINING METHOD FOR IMAGE PROCESSING NETWORK, AND IMAGE PROCESSING METHOD AND APPARATUS

(71) Applicants: SENSETIME GROUP LIMITED, Hong Kong (CN); HONDA MOTOR CO., LTD., Tokyo (JP)

(72) Inventor: Hiroki SAKUMA, Hong Kong (CN)

(73) Assignees: SENSETIME GROUP LIMITED, Hong Kong (CN); HONDA MOTOR CO., LTD., Tokyo (JP)

(21) Appl. No.: 19/002,223

(22) Filed: Dec. 26, 2024

Related U.S. Application Data
(63) Continuation of application No. PCT/CN2023/080349, filed on Mar. 8, 2023.

(30) Foreign Application Priority Data
Jun. 30, 2022 (CN) 202210772860.1

(51) Int. Cl. G06V 10/774; G06V 10/26; G06V 10/776; G06V 10/80; G06V 10/84; G06V 20/70; G06V 40/16

(52) U.S. Cl. CPC G06V 10/774; G06V 10/26; G06V 10/776; G06V 10/803; G06V 10/85; G06V 20/70; G06V 40/171

(57) ABSTRACT

Provided are a method and device for training an image processing network, and an image processing method and device. The method for training an image processing network includes following. A reference pixel is determined based on a training image annotated with a truth value. With the reference pixel as a starting point and based on a Markov chain of the training image, cropping probabilities of the image processing network processing the training image are determined. A network parameter value and the cropping probabilities of the image processing network are adjusted based on an output result obtained by the image processing network processing a training cropped area and the truth value, to obtain a trained image processing network. The training cropped area is obtained by cropping the training image based on the cropping probabilities.

### CROSS-REFERENCE TO RELATED APPLICATION

This application is a continuation of International Application No. PCT/CN2023/080349 filed on Mar. 8, 2023 which claims priority to Chinese Patent Application No. 202210772860.1, filed on Jun. 30, 2022 and entitled “TRAINING METHOD FOR IMAGE PROCESSING NETWORK, AND IMAGE PROCESSING METHOD AND APPARATUS”. The contents of these applications are hereby incorporated by reference in its entireties

### TECHNICAL FIELD

The present disclosure relates to, but is not limited to, the technical field of computer vision, and in particular to a method for training an image processing network, and an image processing method and device.

### BACKGROUND

Channel pruning has been widely used in model acceleration and compression to deploy overparameterized convolutional neural networks (CNNs) for image processing on an embedded device or a mobile device. In related technologies, channel pruning is performed on a network by Differentiable Markov Channel Pruning (DMCP). In the DMCP, the procedure of channel pruning is modeled as a Markov chain to reduce search space. However, in gaze estimation, since training images contain redundant pixels, the gaze estimation performed by a trained image processing network has low accuracy.

### SUMMARY

In view of this, embodiments of the present disclosure provide at least one method and device for training an image processing network, and an image processing method and device.

The technical solutions of the embodiments of the present disclosure are implemented as follows.

In a first aspect, embodiments of the present disclosure provide a method for training an image processing network. The method includes following. A reference pixel is determined based on a training image annotated with a truth value. With the reference pixel as a starting point and based on a Markov chain of the training image, cropping probabilities of the image processing network processing the training image are determined. a network parameter value and the cropping probabilities of the image processing network are adjusted based on an output result obtained by the image processing network processing a training cropped area and based on the truth value, to obtain a trained image processing network. The training cropped area is obtained by cropping the training image based on the cropping probabilities.

In a second aspect, embodiments of the present disclosure provide an image processing method. The method includes following. An image to be processed is acquired. Pixel cropping is performed on the image to be processed based on cropping probabilities of a trained image processing network, to obtain a cropped area to be processed. The trained image processing network is trained based on the method of the first aspect. The cropped area to be processed is processed by using the trained image processing network, to obtain a processing result for the image to be processed.

In a third aspect, embodiments of the present disclosure provide a device for training an image processing network. The device includes a first determination part, a second determination part and a first adjustment part. The first determination part is configured to determine a reference pixel based on a training image annotated with a truth value. The second determination part is configured to determine, with the reference pixel as a starting point and based on a Markov chain of the training image, cropping probabilities of the image processing network processing the training image. The first adjustment part is configured to adjust, based on an output result obtained by the image processing network processing a training cropped area and based on the truth value, a network parameter value and the cropping probabilities of the image processing network to obtain a trained image processing network. The training cropped area is obtained by cropping the training image based on the cropping probabilities.

In a fourth aspect, embodiments of the present disclosure provide an image processing device. The device includes a first acquisition part, a first cropping part and a first processing part. The first acquisition part is configured to acquire an image to be processed. The first cropping part is configured to perform, based on cropping probabilities of a trained image processing network, pixel cropping on the image to be processed, to obtain a cropped area to be processed. The trained image processing network is trained based on the above method for training an image processing network. The first processing part is configured to process the cropped area to be processed by using the trained image processing network, to obtain a processing result for the image to be processed.

In a fifth aspect, embodiments of the present disclosure provide a device for training an image processing network including a memory and a processor. The memory is stored with a computer program executable on the processor, and the processor is configured to execute the program to: determine a reference pixel based on a training image annotated with a truth value; determine, with the reference pixel as a starting point and based on a Markov chain of the training image, cropping probabilities of the image processing network processing the training image; and adjust, based on an output result obtained by the image processing network processing a training cropped area and based on the truth value, a network parameter value and the cropping probabilities of the image processing network to obtain a trained image processing network. The training cropped area is obtained by cropping the training image based on the cropping probabilities.

In a sixth aspect, embodiments of the present disclosure provide a device for training an image processing network including a memory and a processor. The memory is stored with a computer program executable on the processor, and the processor is configured to execute the program to: acquire an image to be processed; perform, based on cropping probabilities of a trained image processing network, pixel cropping on the image to be processed, to obtain a cropped area to be processed, wherein the trained image processing network is trained based on the method of the first aspect; and process the cropped area to be processed by using the trained image processing network, to obtain a processing result for the image to be processed.

In a seventh aspect, embodiments of the present disclosure provide a computer-readable storage medium having stored thereon a computer program that, when executed by a processor, causes the processor to implement a method for training an image processing network, the method including: determining a reference pixel based on a training image annotated with a truth value; determining, with the reference pixel as a starting point and based on a Markov chain of the training image, cropping probabilities of the image processing network processing the training image; and adjusting, based on an output result obtained by the image processing network processing a training cropped area and based on the truth value, a network parameter value and the cropping probabilities of the image processing network to obtain a trained image processing network, wherein the training cropped area is obtained by cropping the training image based on the cropping probabilities.

In an eighth aspect, embodiments of the present disclosure provides a computer-readable storage medium having stored thereon a computer program that, when executed by a processor, causes the processor to implement part or all of operations of the first aspect, or the second aspect.

In a ninth aspect, embodiments of the present disclosure provide a computer program including computer-readable codes that, when executed by a processor in a computer device, cause the processor to implement part or all of operations of the first aspect, or the second aspect.

In a tenth aspect, embodiments of the present disclosure provide a computer program product including a non-transitory computer-readable storage medium storing a computer program that, when read and executed by a computer, causes the computer to implement part or all of operations of the above method of the first aspect, or the second aspect.

It is to be understood that the above general descriptions and detailed descriptions below are only exemplary and explanatory and are not intended to limit the embodiments of the disclosure.

In order to make the above-mentioned purposes, features, and advantages of the embodiments of the present disclosure more obvious and easy to understand, preferred embodiments are specifically given below, and a detailed description is made below in conjunction with the accompanying drawings.

### BRIEF DESCRIPTION OF THE DRAWINGS

The accompanying drawings, which are incorporated in and constitute part of the description, illustrate embodiments consistent with the disclosure and, together with the description, serve to explain the technical solutions the disclosure.

FIG. 1 illustrates a schematic flowchart of implementation of a method for training an image processing network according to embodiments of the present disclosure.

FIG. 2 illustrates another schematic flowchart of implementation of a method for training an image processing network according to embodiments of the present disclosure.

FIG. 3A illustrates a schematic diagram of a system architecture to which an image processing method according to embodiments of the present disclosure may be applied.

FIG. 3B illustrates a schematic flowchart of implementation of an image processing method according to embodiments of the present disclosure.

FIG. 4 illustrates a schematic structural diagram of composition of Markov chains according to embodiments of the present disclosure.

FIG. 5 illustrates a schematic diagram of an application scenario of a method for training an image processing network according to embodiments of the present disclosure.

FIG. 6 illustrates a schematic diagram of an application scenario of an image processing method according to embodiments of the present disclosure.

FIG. 7 illustrates another schematic diagram of an application scenario of a method for training an image processing network according to embodiments of the present disclosure.

FIG. 8A illustrates a schematic structural diagram of composition of a device for training an image processing network according to embodiments of the present disclosure.

FIG. 8B illustrates a schematic structural diagram of composition of an image processing device according to embodiments of the present disclosure.

FIG. 9 illustrates a schematic diagram of hardware entities of a computer device according to embodiments of the present disclosure.

### DETAILED DESCRIPTION

For making the objectives, technical solutions, and advantages of the disclosure clearer, the technical solutions of the present disclosure will further be described below in combination with the drawings and embodiments in detail. The described embodiments should not be considered as limitations to the disclosure. All other embodiments obtained by those of ordinary skill in the art without creative work shall fall within the scope of protection of the disclosure

“Some embodiments” involved in the following descriptions describes a subset of all possible embodiments. However, it can be understood that “some embodiments” may be the same subset or different subsets of all the possible embodiments, and may be combined without conflicts.

Unless otherwise defined, all technological and scientific terms used in the disclosure have meanings the same as those usually understood by those skilled in the art of the disclosure. The terms used in the disclosure are only adopted to describe the disclosure rather than limiting.

Before the embodiments of the disclosure are further described in detail, nouns and terms involved in the embodiments of the disclosure will be explained firstly. The nouns and terms involved in the embodiments of the disclosure are suitable for the following explanations.
1) Computer vision, referring to the machine vision, which uses a camera and a computer to perform recognition, tracking and measurement on a target instead of human eyes, and further performs graphic processing so that the image processed by the computer becomes more suitable for human eyes to observe or for transmitting to instruments for detection.
2) Model compression, with the purpose of reducing the computation quantity of a model, reducing the number of parameters/volume of the model, and reducing the inference time of the model.
3) Markov chain, which is a set of discrete random variables. For example, for a given set of random variables, if values of the random variables are all in a countable set, the set of discrete random variables is called a Markov chain, the countable set is called a state space, and the value of the Markov chain in the state space is called a state. The Markov property, also known as “memorylessness”, means that after a random variable at step t is given, a random variable at the step t+1 is conditionally independent from remaining random variables. In the embodiments of the present disclosure, a cropping operation performed on an input image is modeled as a Markov chain, such that a cropping probability for a pixel depends on a cropping probability for an immediately previous pixel.

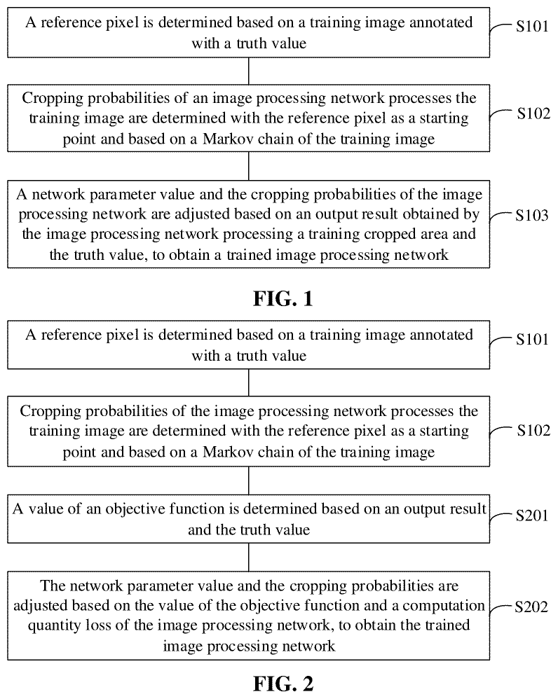

Embodiments of the present disclosure provide a method for training an image processing network that may be performed by a processor of a computer device. The computer device may be a device having data processing capability, such as a server, a laptop, a tablet, a desktop, a smart TV, or a mobile device (such as a mobile phone, a portable video player, a personal digital assistant, a dedicated messaging device, or a portable game device). FIG. 1 illustrates a schematic flowchart of implementation of a method for training an image processing network according to embodiments of the present disclosure. As illustrated in FIG. 1, the method includes operations S101 to S103 as follows.

In operation S101, a reference pixel is determined based on a training image [0038] annotated with a truth value.

In some embodiments, training images may be sample images annotated with truth values, and picture scenes of the training images may be selected based on a task of the image processing network to be trained. The training images may be images with complex picture contents or images with simple picture contents. In some possible implementations, if the task of the image processing network is gaze estimation, then the training images may be captured images containing eyes at various angles of view, and annotated truth values are gazes of the eyes. If the task of the image processing network is eye detection, the training images may be captured images containing faces, and the annotated truth values are eyes in the faces. If the task of the image processing network is vehicle recognition, the training images are captured images of traffic scenes, and the annotated truth values are vehicles in the images.

In some embodiments, the reference pixel may be a pixel selected from any training image, and the reference pixel is used for representing the center position of an image area that needs to be retained during pixel cropping. In this way, the reference pixel may be a center pixel of the training image, or may be a pixel at a preset position in the training image. The preset position may be a position defined by a user, or may be a position within a certain range in the training image, such as an image area where a circle with a radius being a quarter of the width of the training image is located in the training image. In the process of network training, for each training image, a reference pixel is selected as the center pixel of the image area to be retained. In this way, by selecting the reference pixel in the training image, subsequent selection of the image area to be retained in the training image is facilitated.

In operation S102, cropping probabilities of the image processing network processing the training image are determined with the reference pixel as a starting point and based on a Markov chain of the training image.

In some embodiments, for any training image, a cropping probability for cropping a pixel of the training image is determined by taking the reference pixel of the training image as a starting point and according to the Markov chain of the training image. The Markov chain of the training image may mean that the process of cropping the training image is modeled as the Markov chain. A state in the Markov chain corresponds to that a pixel is retained, and a transition probability between two adjacent states corresponds to a retaining probability for a next one of two adjacent pixels under the condition that a former one of the adjacent pixels is retained. The retaining probability for each pixel may be calculated by a product of transition probabilities, and is regarded as the importance of the pixel.

In some possible implementations, in the process of network training, taking the reference pixel of the training image as the starting point, the cropping probability for the next pixel adjacent to the reference pixel in the training image may be determined by the cropping probability for the reference pixel in the Markov chain; thus the cropping probability for each pixel of the training image may be determined. In this way, by modeling the cropping operation performed on the training image as a Markov process, the cropping probability of retaining each pixel of the training image can be analyzed by taking the reference pixel as a starting point.

In operation S103, a network parameter value and the cropping probabilities of the image processing network are adjusted based on an output result obtained by the image processing network processing a training cropped area and based on the truth value, to obtain a trained image processing network.

In some embodiments, the output result is related to a function implemented by the image processing network. If the function implemented by the image processing network is gaze estimation, then the output result is a prediction result of estimating a gaze in the training image by the image processing network. In this way, the loss of the image processing network may be determined by the output result and the annotated truth value, and then the network parameter value and the cropping probabilities of the image processing network may be adjusted by the loss, so that the loss output by the trained image processing network converges.

In some possible implementations, the network parameter value of the image processing network at least includes weights, and may further include a pruning probability of a channel to be pruned. In the process of network training, at least the weight and the cropping probabilities are optimized to obtain the trained image processing network including the adjusted cropping probabilities and the adjusted network parameter value.

In some embodiments, the training cropped area is obtained by cropping the training image based on the cropping probabilities. In the process of network training, after the cropping probability for each pixel is determined by the Markov chain, the training image is cropped by using the cropping probabilities, and then a cropped area is processed by the image processing network to optimize the image processing network. In a specific example, taking the function of the image processing network being gaze estimation as an example, the obtained output result is a result of gaze estimation, which may be implemented by the following operations.

In a first operation, a training cropped area of the training image is determined based on the cropping probabilities of the image processing network.

In some embodiments, in the training image, the training image is cropped by using the cropping probability corresponding to each pixel, to obtain the training cropped area of the training image. In some possible implementations, the cropping probabilities for multiple pixels in the training image are expressed as a vector, and the vector is multiplied by a vector representing the multiple pixels of the image, and an obtained product is the training cropped area of the training image.

In a second operation, gaze estimation is performed on the training cropped area by using the image processing network, to obtain the output result.

In some embodiments, the image processing network is a network for gaze estimation, then the cropped training image, i.e., the training cropped area of the training image, is inputted into the image processing network to perform gaze estimation, to obtain an output result. In this way, applying the cropped training image to the training process, the transition probabilities between pixels in the Markov chain can be optimized.

In the embodiments of the present disclosure, by determining a reference pixel in a training image annotated with a truth value, it is convenient to subsequently select an image area to be retained in the training image. Then, taking the reference pixel as a starting point, a cropping operation to be performed on the training image is modeled as a Markov process, which combined with the reference pixel taken as the starting point enables a cropping probability of retaining each pixel in the training image to be analyzed. Finally, through an output result of the image processing network making prediction for the training image and a truth value of the training image, network parameter values of the image processing network and the cropping probability of the image processing network for each pixel are optimized to obtain the trained image processing network. In this way, the cropping probabilities for the training image are estimated by introducing the Markov chain, and the cropping probabilities and the network parameter value are adjusted by the output result for the training image and truth value of the training image, so that the image processing performance of the image processing network can be optimized.

In some embodiments, the image processing network may be a neural network for implementing gaze estimation. In this case, the training image is a face image annotated with gaze information, i.e., the truth value is annotated gaze information of eyes in the face. In this case, the output result corresponding to the training image includes a prediction result obtained by the image processing network performing gaze estimation on the training image. In this way, the image processing network is trained by using the training image annotated with the gaze information, and the Markov chain is introduced to crop the pixels of the training image during implementation so that the network is trained by using the cropped image, which can improve the accuracy of the trained image processing network in gaze estimation.

In some possible implementations, in the scenario of gaze estimation, the annotated gaze information and gaze information in the output result corresponding to the training image include at least one of the following: a pitch angle of a gaze, a yaw angle of the gaze, or a roll angle of the gaze. In this way, by introducing gazes of various angles of view into the annotated gaze information, the gaze types in training images can be enriched, and the trained image processing network can accurately predict gazes under various angles of view.

In some embodiments, by taking a center pixel of the training image as a reference pixel, the cropping probability for each pixel of the training image can be determined by taking the center pixel as the starting point. That is to say, the operation S101 may be implemented by the following operation S111 (not shown).

In operation S111, a center pixel of the training image is determined as the reference pixel.

Herein, during the process of training the image processing network, for each batch of training images inputted into the image processing network, a pixel located at a center position of a training image, i.e., a center pixel, is determined. In the process of image capturing, an interested area may be close to the center of the image; therefore, the center pixel determined in the training image is likely to be contained in the interested area.

Herein, the center pixel is taken as a reference pixel, so that the cropping probability for each pixel is determined by taking the center pixel as the starting point. Since the probability for the center pixel being contained in the interested area is relatively high, a probability that the finally obtained cropped area contains the interested area is relatively high if the center pixel is taken as the starting point.

In the operation S111 mentioned above, by taking the center pixel of the training image as the reference pixel, the probability that the cropped area finally obtained based on the center pixel contains the interested area can be higher.

After the reference pixel is set through the operation S111, the above operation S102 may be implemented by a following operation S112 (not shown).

In operation S112, a cropping probability for each pixel in the training image is determined with the center pixel as the starting point and based on the Markov chain.

Herein, in the training image, by taking the center pixel as a starting point, a cropping probability for a next pixel of the center pixel may be determined according to the cropping probability for the center pixel in the Markov chain; as such the cropping probability for each pixel of the training image may be obtained.

In some possible implementations, given the cropping probability for the center pixel in the Markov chain and determining a transition probability of a next pixel from the center pixel in the Markov chain, transition probabilities of all pixels before the next pixel are multiplied to obtain the cropping probability for the next pixel.

In the embodiments of the present disclosure, by taking the center pixel of the training image as the starting point and combined with the cropping probability for the center pixel in the Markov chain, the cropping probabilities for the other pixels can be quickly and accurately obtained.

In some embodiments, during the process of determining the cropping probability for each pixel, the transition probabilities from the center pixel to the other pixels are respectively obtained through the Markov chain, then the cropping probabilities for all pixels may be obtained through the transition probabilities. That is to say, the above operation S113 may be implemented by following operations.

In a first operation, a transition probability of a next pixel from the center pixel is determined in the Markov chain.

In some embodiments, since each state in the Markov chain indicates that a pixel corresponding to the state is retained, the transition probability from the center pixel to a retained next pixel can be obtained.

In a second operation, a cropping probability for the next pixel is determined based on the transition probability of the next pixel and the transition probabilities of multiple pixels before the next pixel.

In some embodiments, the transition probability is multiplied by the transition probabilities corresponding to all pixels before the next pixel, to obtain the cropping probability for the next pixel. In this way, the transition probability from the center pixel to the retained next pixel is obtained through the Markov chain, and the cropping probability for the next pixel is obtained by multiplying multiple transition probabilities, so that the training image may be cropped through the cropping probabilities to optimize the training image.

In some embodiments, the cropping probability for a pixel may be determined in two manners.

In a first manner, based on a Markov chain in at least one direction starting from the center pixel, cropping probabilities for all pixels in the at least one direction starting from the center pixel are isotropically set.

Herein, for the at least one direction from the center pixel, cropping probabilities are isotropically set according to the Markov chain. In this way, the cropping probabilities are the same for pixels in multiple directions starting from the center pixel. The at least one direction includes: a leftward direction, a rightward direction, an upward direction or a downward direction starting from the center pixel. The at least one direction may also include a direction having a certain angle with the horizontal direction or the vertical direction. For example, taking the center pixel as the origin, the at least one direction may include positive and negative directions of the X axis where the origin is located. In this way, in the training image, for each of the at least one direction starting from the center pixel, a cropping probability for each pixel in the direction is obtained through the transition probabilities between pixels in the Markov chain. Thus, whether the pixels along each direction need to be retained respectively are accurately determined. Moreover, the probabilities for pixels to be retained are the same for each direction.

In a second manner, based on Markov chains along symmetric propagation directions starting from the center pixel, a cropping probability for each pixel along the symmetric propagation directions starting from the center pixel is set.

Herein, in the training image, taking the center pixel as the symmetric point and based on the Markov chains having symmetric propagation directions from the symmetric point, the cropping probabilities for corresponding pixels in the symmetric propagation directions are determined. That is to say, the cropping probabilities for the pixels are set according to the Markov chains having left-right symmetric propagation directions starting from the center pixel. For example, the symmetric propagation directions starting from the center pixel may be understood as the positive and negative directions of the X axis, or the positive and negative directions of the Y axis in the two-dimensional coordinate system taking the center pixel as the origin. In this way, taking the center pixel as the symmetric point, the cropping probabilities for pixels in an area with mutually symmetric parts to be retained are determined, so that the cropped area remained after the training image is finally cropped is located in the middle area of the image, and the probability of the cropped area including the interested area is higher.

In some embodiments, after the training cropped area is determined, the cropped area may be further optimized in two following manners.

In a first manner: in a first operation, a line including a center pixel of the training image is determined in the training image.

Herein, after the center pixel is determined in the training image, corresponding pixels including the center pixel is determined as a line, which may be any line passing through the point where the center pixel is located in the training image. In this case, the line may be a vertical line, a horizontal line, or a slash line.

In a second operation, the training cropped area is corrected into an axisymmetric area with the line as a symmetric axis.

Herein, the training cropped area is corrected according to the line, so that the cropped area is corrected into a line symmetric area that is symmetric based on the line including the center pixel. In this way, the training cropped area is a line symmetric area, with the line being the symmetric axis.

In the first and second operations above, the training cropped area is corrected into an axisymmetric area with the line where the center pixel is located as a symmetric axis in the training image. In this way, the corrected training cropped area includes the pixels of the central area of the training image, and the training cropped area is more conducive to gaze estimation.

In a second manner, the training cropped area is corrected into a centrosymmetric area with the center pixel as a symmetric center.

Herein, the training cropped area is corrected by taking the center pixel as the symmetric point, so that the corrected training cropped area is a point symmetric area with the center pixel as the symmetric point. In this way, the corrected training cropped area is more likely to include the center area of the training image, and furthermore, the probability that the training cropped area includes an eye image for gaze estimation is higher.

In some embodiments, the cropping probabilities and the weights of the network are optimized by a value satisfying an objective function containing the difference between the truth value and the output result. That is to say, the operation S103 may be achieved by operations as illustrated in FIG. 2.

In operation S201, a value of an objective function is determined based on the output result and the truth value.

In some embodiments, the difference between the output result and the truth value is obtained by comparing the output result of the image processing network with the truth value of the training image. Based on the difference, a loss function of the image processing network obtaining the output result through prediction is obtained, and the loss function is the objective function.

In some possible implementations, the value of the objective function is a task loss of the image processing network. During the training process, by comparing the output result for the whole training image with the output result corresponding to the training cropped area that are predicted by the image processing network, the task loss, i.e., the value of the objective function, is obtained. The objective function may be a loss function for training a network parameter value of the image processing network itself, such as, a weight and a pruning probability of the channel to be pruned in the image processing network. The weights in the image processing network and the transition probabilities in the Markov chain are updated alternately.

In operation S202, the network parameter value and the cropping probabilities are adjusted based on the value of the objective function and a computation quantity loss of the image processing network, to obtain the trained image processing network.

In some embodiments, the computation quantity loss of the image processing network represents a difference between an expected computation quantity of the image processing network and an actual computation quantity of the image processing network. For example, the difference between the expected computation quantity of the image processing network and the actual computation quantity of the image processing network is taken as the computation quantity loss. In this way, the value of the objective function is combined with the computation quantity loss of the image processing network, to update the network parameter value and the cropping probabilities of the image processing network alternately, thus implementing the training of the image processing network and obtaining the trained image processing network.

In the embodiments of the present disclosure, the value of the objective function is obtained by the difference between the output result for the training image and the truth value of the training image, and the value of the objective function is combined with the computation quantity loss of the image processing network. The weights, the cropping probabilities of the image processing network or the like are optimized by the combined losses, so that the optimized weights and the optimized cropping probabilities in the trained image processing network are better.

In some embodiments, the value of the objective function is obtained by comparing the output result for the training cropped area with the output result for the whole training image. That is to say, the operation S201 may be achieved by following operations S211 to S213 (not shown).

In operation S211, the output result is fused with the truth value to obtain a first fusion result of the training cropped area.

In some embodiments, during the training of the image processing network for gaze estimation, the first fusion result is obtained by element-by-element multiplying the output result corresponding to the training cropped area, i.e., the output result of the image processing network performing gaze estimation on the training cropped area, by the truth value of the training image corresponding to the training cropped area.

In operation S212, a result of the image processing network performing gaze estimation on the training image is fused with the truth value, to obtain a second fusion result of the training image.

In some embodiments, during the process of training the image processing network for gaze estimation, the second fusion result is obtained by element-by-element multiplying the output result corresponding to the whole training image, i.e., the output result of the image processing network performing gaze estimation on the whole training image, by the truth value of the training image.

In operation S213, the value of the objective function is obtained based on a ratio of the first fusion result to the second fusion result.

In some embodiments, the first fusion result and the second fusion result are respectively serialized, and a ratio between the serialized first fusion result and the serialized second fusion result is determined. In this way, for any training image, an expectation of the training image is determined based on the ratio, and the expectation is determined as the value of the objective function.

In the embodiments of the present disclosure, by comparing the first fusion result of the training cropped area with the second fusion result of the training image, a difference between the result of the image processing network performing gaze estimation on the training cropped area and the result of the image processing network performing gaze estimation on the whole training image is obtained, and the difference is expressed as the value of the objective function. Therefore, network parameter values, such as weights, of the image processing network can be optimized by the value of the objective function.

In some embodiments, the channels to be pruned of the image processing network are optimized while optimizing the network parameter values of the image processing network. That is to say, the channels of the image processing network are pruned while the training image input into the image processing network is cropped, so as to obtain a trained image processing network having better performance. That is to say, the operation S202 may be implemented by following operations S221 and S222 (not shown).

In operation S221, a transition loss is obtained based on the value of the objective function and the computation quantity loss.

In some embodiments, during the training of the image processing network, the transition loss is obtained by element-by-element addition of the value of the objective function to the computation quantity loss.

In operation S222, the weight and the pruning probability of the channel to be pruned are adjusted based on the value of the objective function, and the cropping probabilities are adjusted based on the transition loss, to obtain the trained image processing network.

In some embodiments, the weights of the image processing network and the pruning probabilities of the channels to be pruned are simultaneously optimized according to the value of the objective function. In this way, the channels of the image processing network are pruned by the optimized pruning probabilities, to compress the image processing network, thereby making the image processing network more portable. While channels are pruned, the cropping probabilities for the pixels of the input training image are optimized, so that the training image is cropped according to the optimized cropping probabilities, to improve the effectiveness of the training image.

In the embodiments of the present disclosure, the cropping probabilities are optimized by the transition loss, so that the adjusted cropping probabilities are optimized. The weights and the pruning probabilities of the channels to be pruned are optimized by the value of the objective function, so that the pixel cropping is performed on the input training image while performing the channel cropping on the image processing network. Therefore, the accuracy of the trained image processing network performing gaze estimation can be improved.

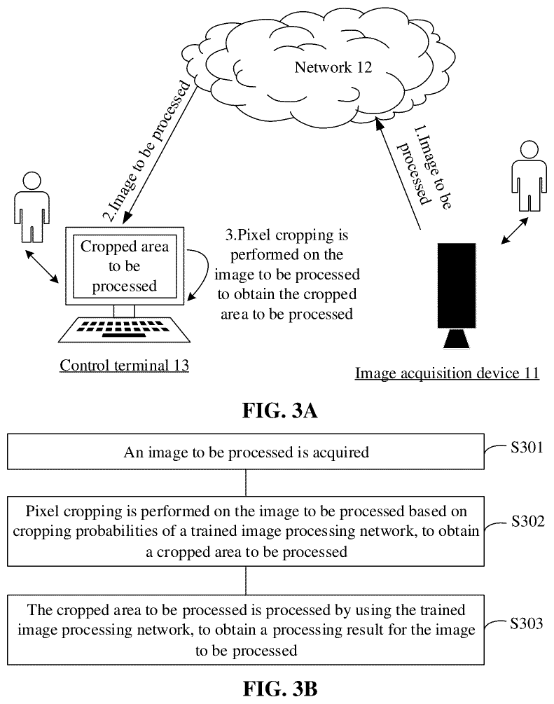

The embodiments of the present disclosure provide an image processing method that may be applied to an electronic device. FIG. 3A illustrates a schematic diagram of a system architecture to which an image processing method according to embodiments of the present disclosure may be applied. As illustrated in FIG. 3A, the system architecture includes: an image acquisition device 11, a network 12, and a control terminal 13. In order to support an exemplary application, the image acquisition device 11 establishes a communication connection with the control terminal 13 through the network 12. Firstly, the image acquisition device 11 reports an acquired image to be processed to the control terminal 13 through the network 12, and the control terminal 13 performs pixel cropping on the image to be processed through the cropping probabilities of the trained image processing network, to obtain a cropped area to be processed.

As an example, the image acquisition device 11 may include a visual processing device having visual information processing capability. The network 12 may be in wired or wireless form. When the image acquisition device 11 is the vision processing device, the control terminal 13 may communicate with the vision processing device through a wired connection, such as performing data communication through a bus.

Alternatively, in some scenarios, the image acquisition device 11 may be a visual processing device with a video capture module or a host with a camera. In this case, the image processing method in the embodiments of the present disclosure may be performed by the image acquisition device 11, and the above system architecture may not include the network 12 or the control terminal 13.

In order to make the objectives, technical solutions and advantages of the embodiments of the present disclosure clearer, the specific technical solutions of the present disclosure will further be described below in combination with the drawings in the embodiments of the present disclosure in detail. The following embodiments are configured to illustrate the disclosure, but are not intended to limit the scope of the disclosure.

“Some embodiments” involved in the following descriptions describe a subset of all possible embodiments. However, it may be understood that “some embodiments” may be the same subset or different subsets of all the possible embodiments, and may be combined without conflicts.

FIG. 3B illustrates a schematic flowchart of implementation of an image processing method according to embodiments of the present disclosure, and following descriptions are made in combination with the operations shown in FIG. 3B.

In operation S301, an image to be processed is acquired.

Herein, the image to be processed may be an image captured in any scene, and may be an image with simple picture content or an image with complex picture content. The image to be processed may be an image acquired in any scene, and may be an image acquired by an image acquisition device, such as a camera, or an image received from another device. The image to be processed may also be an image to be subjected to gaze estimation, for example, a face image containing eyes, or a human body image containing eyes. For example, in a traffic scene, the image to be subjected to gaze estimation is a face image, an eye image or the like of a driver driving a vehicle, or may be a face image, an eye image or the like of a passenger in the vehicle. In the application scenario of a smart device, the image to be subjected to gaze estimation may be a face image or an eye image of a person controlling the smart device, and the smart device is controlled based on a direction of gaze by performing gaze estimation on the image of the person.

In operation S302, pixel cropping is performed on the image to be processed based on cropping probabilities of a trained image processing network, to obtain a cropped area to be processed.

Herein, the trained image processing network may be trained based on the method for training an image processing network provided in the above-described embodiments. The acquired image to be processed is input into the trained image processing network to obtain the cropped area to be processed. In the image processing network, the optimized cropping probabilities are multiplied by a vector representing the image to be processed, to implement pixel cropping on the image to be processed. The obtained product is the cropped area to be processed.

In operation S303, the cropped area to be processed is processed by using the trained image processing network, to obtain a processing result for the image to be processed.

Herein, after the pixel cropping is performed on the image to be processed, the trained image processing network is used to process the cropped area to be processed, so that the accuracy of the obtained processing result can be improved.

In some possible implementations, with the trained image processing network being used to perform gaze estimation on the image as an example, after the cropping probabilities of the image processing network are optimized, the acquired image is cropped by the optimized cropping probabilities during gaze estimation, so as to obtain a gaze estimation result for the image, which may be implemented through a following procedure.

The trained image processing network is used to perform gaze estimation on the [00117] cropped area to be processed, to obtain the processing result for the image to be processed.

Herein, in the scenario of gaze estimation, the optimized cropping probabilities in the trained image processing network are used to crop the image to be processed which needs gaze estimation, to obtain the cropped area to be processed. In this case, the picture content in the cropped area to be processed is the interested area, for example, the eye area. In this way, by performing gaze estimation based on the cropped area to be processed, the accuracy of gaze estimation can be further improved.

An application of the image processing method provided by the embodiments of the present disclosure in an actual scenario will be described below, and the description is made with model lightweight for a gaze estimation model as an example.

In the related technologies, channel pruning is applied in model acceleration and model compression, to deploy parameterized convolutional neural network on an embedded device or a mobile device. In some tasks, a subarea of each input image may be cropped to reduce the computation cost. For example, in appearance-based gaze estimation, each input image is usually normalized, so that the center of an eye or face is located at the center of the image. In this case, it may be assumed that important pixels are distributed around the center of the image, and the subarea of the input image at the center may be cropped to reduce the computation cost. However, in many cases, since which area the important pixels are distributed in cannot be determined, a full-face image is used as an input of a gaze estimator. However, under given computation constraints, whether it is optimal to use the full-face image cannot be determined.

Based on this, in order to find a common optimal area in the input image, the embodiments of the present disclosure introduce a new model acceleration concept, i.e., pixel pruning; and propose a new differentiable pixel pruning method, called Differentiable Markov Pixel Pruning (DMPP). Redundant pixels in the input image are searched based on a task loss and computation constraints. In the DMPP, the pixel pruning process is modeled as a Markov chain, and the found redundant pixels may be pruned by simple cropping operations during inference. Moreover, it is more effective to jointly prune channels and pixels than to only prune channels in gaze estimation.

In the method for training an image processing network provided by the embodiments of the present disclosure, the pruning process is reformulated by using multiple Markov chains. The pixel pruning using multiple Markov chains may be achieved through the following process.

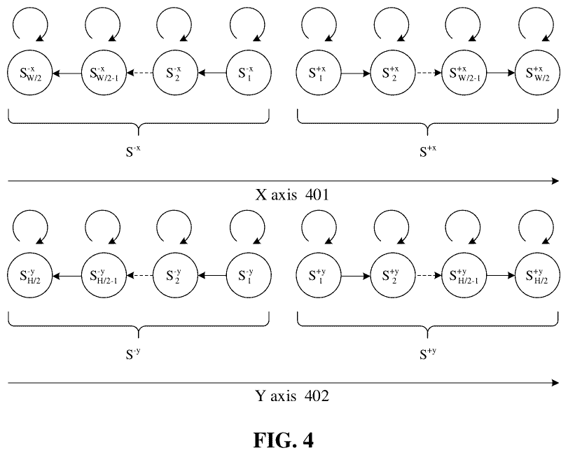

The input image is represented as I∈[0, 1]^{C×2H×2W}, where C, H and W respectively represent: the number of channels, a half-height and a half-width of the image. Four sets of random variables {Zₜ^{+x}}ₜ₌₁^{w}, {Zₜ^{-x}}ₜ₌₁^{w}, {Zₜ^{-y}}ₜ₌₁^{H}, and {Zₜ^{-y}}ₜ₌₁^{H} are provided in the embodiments of the present disclosure, and state spaces S^{+x}, S^{-x}, S^{+y}, and S^{-y} corresponding to these random variables may be expressed as following formulas (1) to (4):

$${S}^{+ x} = {\{ {s}_{k}^{+ x} \}}_{k = 1}^{W} ; \qquad ( 1 )$$

$${S}^{- x} = {\{ {s}_{k}^{- x} \}}_{k = 1}^{W} ; \qquad ( 2 )$$

$${S}^{+ y} = {\{ {s}_{k}^{+ y} \}}_{k = 1}^{H} ; \qquad ( 3 )$$

$${S}^{- y} = {\{ {s}_{k}^{- y} \}}_{k = 1}^{H} ; \qquad ( 4 )$$

where sₖ^{+x}, sₖ^{-x}, sₖ^{+y}, and sₖ^{-y} represent that pixels {I_{i,j}|i<W+k}, {I_{i,j}|i≥W−k}, {I_{i,j}|i<H+k}, and {I_{i,j}|i≥H−k} are retained respectively. As illustrated in FIG. 4, pixel pruning is modeled as multiple Markov chains, and sₖ^{+x}, sₖ^{-x}, sₖ^{+y}, and sₖ^{-y} respectively represent that k pixels counted from a center pixel in the directions +x, −x, +y, and −y are to be retained.

In FIG. 4, the Markov chains on the X-axis 401 includes state spaces S^{-x} and S^{+x}. States of S^{-x} include s_{W}^{-x}, s_{W-1}^{-x}, . . . , and s₁^{-x}. States of S^{+x} includes s₁⁺x, s₂^{+x}, . . . , and s_{W}^{+x}.

The Markov chains on the Y-axis 402 includes state spaces S^{-y} and S^{+y}. States of S^{-y} includes spy, s_{H}^{-y}, s_{H-1}^{-y}, . . . , and s₁^{-y}, and states of S^{+y} includes s₁^{+y}, s₂^{+y}, . . . s_{H-1}⁺and s_{H}^{+y}.

In the embodiments of the present disclosure, the optimal cropped area may be annotated by using a rectangular box, and a rectangle remained after cropping may be represented by a set of random variables {Z_{W}^{+x},Z_{W}^{-x},Z_{H}^{+y},Z_{H}^{-y}}. For example, if Z_{W}^{+x}=Sᵢ_{ₘₐₓ}^{+x}, Z_{W}^{-x}=sᵢ_{ₘᵢₙ}^{-x}, Z_{H}^{+y}=sⱼ_{ₘₐₓ}^{+y}, and Z_{H}^{-y}=sⱼ_{ₘᵢₙ}^{-y} are satisfied, then the rectangular box remained after cropping may be represented as (iₘᵢₙ,jₘᵢₙ,iₘₐₓ,jₘₐₓ), where (iₘᵢₙ,jₘᵢₙ) and (iₘₐₓ,jₘₐₓ) respectively represent coordinates of the bottom-left vertex and the top-right vertex of the rectangular box.

To learn the optimal area to be remained after cropping, a transition probability is parameterized as shown in formulas (5) to (8).

$$p ( {Z}_{t}^{+ x} = {s}_{k}^{+ x} \vert {Z}_{t - 1}^{+ x} = {s}_{k - 1}^{+ x} ) = \{ \begin{matrix}σ ( {∅}_{k}^{+ x} ) & if t = k \\ 0 & otherwise\end{matrix} ; \qquad ( 5 )$$

$$p ( {Z}_{t}^{- x} = {s}_{k}^{- x} \vert {Z}_{t - 1}^{- x} = {s}_{k - 1}^{- x} ) = \{ \begin{matrix}σ ( {∅}_{k}^{- x} ) & if t = k \\ 0 & otherwise\end{matrix} ; \qquad ( 6 )$$

$$p ( {Z}_{t}^{+ y} = {s}_{k}^{+ y} \vert {Z}_{t - 1}^{+ y} = {s}_{k - 1}^{+ y} ) = \{ \begin{matrix}σ ( {∅}_{k}^{+ y} ) & if t = k \\ 0 & otherwise\end{matrix} ; \qquad ( 7 )$$

$$p ( {Z}_{t}^{- y} = {s}_{k}^{- y} \vert {Z}_{t - 1}^{-} = {s}_{k - 1}^{-} ) = \{ \begin{matrix}σ ( {∅}_{k}^{-} ) & if t = k \\ 0 & otherwise\end{matrix} ; \qquad ( 8 )$$

where σ(•) represents a sigmoid function, {Øₖ^{+x}}ₖ₌₁^{W}, {Øₖ^{-x}}ₖ₌₁^{W}, {Øₖ^{+y}}ₖ₌₁^{H}, and {Øₖ^{-y}}ₖ₌₁^{H} represent learnable parameter sets. Thus, the edge probabilities {I_{i,j}|i<W+k}, {I_{i,j}|i≥W−k}, {I_{i,j}|i<H+k}, and {I_{i,j}|i≥H−k} of the retained pixels are respectively represented as, pₖ^{+x}, pₖ^{-x}, pₖ^{+y} and pₖ^{-y}, as shown by formulas (9) to (12).

$${p}_{k}^{+ x} = p ( {Z}_{W}^{+ x} ϵ {\{ {S}_{{k}^{′}}^{+ x} \}}_{{k}^{′} = k}^{W} ) = {∐}_{{k}^{′} = 1}^{k} σ ( {∅}_{{k}^{′}}^{+ x} ) ; \qquad ( 9 )$$

$${p}_{k}^{- x} = p ( {Z}_{W}^{- x} ϵ {\{ {S}_{{k}^{′}}^{- x} \}}_{{k}^{′} = k}^{W} ) = {∐}_{{k}^{′} = 1}^{k} σ ( {∅}_{{k}^{′}}^{+ x} ) ; \qquad ( 10 )$$

$${p}_{k}^{+ y} = p ( {Z}_{W}^{+ y} ϵ {\{ {S}_{{k}^{′}}^{+ y} \}}_{{k}^{′} = k}^{H} ) = {∐}_{{k}^{′} = 1}^{k} σ ( {∅}_{{k}^{′}}^{+ y} ) ; \qquad ( 11 )$$

$${p}_{k}^{- y} = p ( {Z}_{W}^{- y} ϵ {\{ {S}_{{k}^{′}}^{- y} \}}_{{k}^{′} = k}^{H} ) = {∐}_{{k}^{′} = 1}^{k} σ ( {∅}_{{k}^{′}}^{- y} ) . \qquad ( 12 )$$

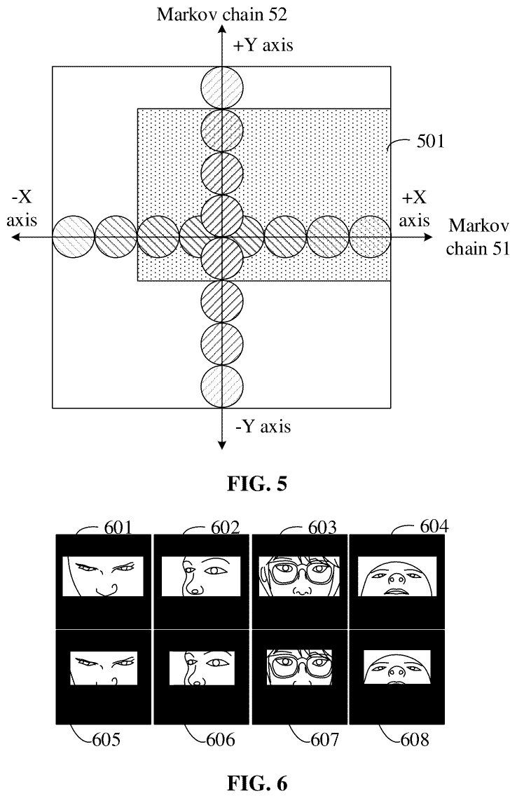

In the embodiments of the present disclosure, the transition probability between states may be optimized in an end-to-end manner by multiplying each input image by edge probabilities for all pixel to be retained respectively. The resulted softly pruned image is differentiable in terms of the transition probabilities, and the learnable transition probabilities may be optimized in an end-to-end manner. For the given image I, the softly pruned image Î may be represented as formulas (13) and (14).

$$\hat{I} = I ⊙ M ; \qquad ( 13 )$$

$${M}_{i , j} = \{ \begin{matrix}{p}_{i - W + 1}^{+ x} {p}_{j - H + 1}^{+ y} if i \geq W , j \geq H \\ {p}_{i - W + 1}^{+ x} {p}_{H - j}^{- y} if i \geq W , j < H \\ {p}_{W - i}^{+ x} {p}_{j - H + 1}^{+ y} if i < W , j \geq H \\ {p}_{W - i}^{- x} {p}_{H - j}^{- y} if i < W , j \geq H\end{matrix} ; \qquad ( 14 )$$

where ⊙ represents the product between elements. As illustrated in FIG. 5, cropping probabilities for the input image are determined based on the Markov chains 51 corresponding to the positive and negative X axis and the Markov chains 52 corresponding to the positive and negative Y axis, and the image is cropped by the cropping probabilities to obtain a cropped area 501. That is to say, the cropped area 501 represents the image remained after cropping, and each input image is multiplied by the edge probabilities for retaining pixels respectively. The resulted softly pruned image (i.e., the cropped area 501) is differentiable in terms of the transition probabilities. The image obtained after the pixel soft pruning is as illustrated in FIG. 6. Each of original images is multiplied by respective learned edge probabilities for retained pixels in the original image in an element-wise manner, so as to obtain the images 601 to 608 in FIG. 6. A target floating-point operations per second (FLOP) of each of the images 601 to 604 is equal to 0.5 G, and the target FLOP of each of the images 605 to 608 is equal to 0.5 G. The image 601 and the image 605 have the same picture content, but have different target FLOPs. The image 602 and the image 606 have the same picture content, but have different target FLOPs. The image 603 and the image 607 have the same picture content, but have different target FLOPs. The image 604 and the image 608 have the same picture content, but have different target FLOPs.

In the embodiments of the present disclosure, budget regularization is performed on the Markov chain, and a set FLOP is used as the target of the budget regularization based on the DMCP. For a given image I∈[0, 1]^{C×2H×2W}, the expected image size (2Ŵ,2Ĥ)=(ŵ⁺+ŵ⁻,ĥ⁺+ĥ⁻) after the pixel pruning is calculated as follows:

$$\begin{matrix}{\hat{ω}}^{+} = E \vert {Z}_{W}^{+ x} \vert = {\sum }_{k = 1}^{W} k \times p ( {Z}_{W}^{+ x} = {s}_{k}^{+ x} ) \\ = {\sum }_{k = 1}^{W} k \times p ( {Z}_{k}^{+ x} = {s}_{k}^{+ x} ) p ( {Z}_{k + 1}^{+ x} = {s}_{k}^{+ x} \vert {Z}_{k}^{+ x} = {s}_{k}^{+ x} ) \\ = {\sum }_{k = 1}^{W} k \times {∐}_{{k}^{′} = 1}^{k} σ ( {∅}_{{k}^{′}}^{+ x} ) ) ( 1 - σ ( {∅}_{k + 1}^{+ x} ) \\ = {\sum }_{k = 1}^{W} {∐}_{{k}^{′} = 1}^{k} σ ( {∅}_{{k}^{′}}^{+ x} ) = {∐}_{k = 1}^{k} {p}_{k}^{+ x}\end{matrix} ; \qquad ( 15 )$$

Similarly:

$${\hat{ω}}^{-} = {\sum }_{k = 1}^{K} {p}_{k}^{- y} , {\hat{h}}^{+} = {\sum }_{k = 1}^{H} {p}_{k}^{+ y} , and {\hat{h}}^{-} = {\sum }_{k = 1}^{H} {p}_{k}^{- y} . \qquad ( 16 )$$

Herein, the expected image size (2Ŵ,2Ĥ) is used for calculating the expected FLOP of the whole network. Let FLOPₛ exp(Φ) be the expected FLOP of the whole network, and FLOPₛtgt be the target FLOP, where Φ={{ϕₖ^{+x}}ₖ₌₁^{W}, {ϕₖ^{-x}}ₖ₌₁^{W}, {ϕₖ^{+y}}ₖ₌₁^{H}, {ϕₖ^{-y}}ₖ₌₁^{H}}. The loss of the budget regularization is as shown in formula (17):

$${L}_{budget} ( Φ ) = log ( max ( \frac{{FLOP}_{s} exp ( Φ )}{{FLOP}_{s} tgt} , 1 ) ) . \qquad ( 17 )$$

Herein, the loss of the budget regularization may be the computation quantity loss in the above-described embodiments.

In the embodiments of the present disclosure, the weight of the network and the transition probabilities of the Markov chain are alternately updated during training. The loss function of the weight is the task loss, i.e., the gaze angular loss in the embodiments of the present disclosure, and the formulas of which are as follows:

$${L}_{task} ( θ , Φ ) = {E}_{I , g} [ across ( \frac{F ( P ( I ; Φ ) ; θ ) \cdot g}{‖ F ( P ( I ; θ ) ) ‖ ‖ g ‖} ) ] ; \qquad ( 18 )$$

$${L}_{weight} ( θ , Φ ) = {L}_{task} ( θ , Φ ) ; \qquad ( 19 )$$

where I represents the image, g represents the truth value of a gaze direction, F(;θ) represents a gaze estimator parameterized by θ, and P(;Φ) represents a candidate DMPP cropper parameterized by Φ. Herein, the gaze angular loss corresponds to the value of the objective function in the above-described embodiments. During implementation, in order to update the weights, the gradient will not be propagated to the transformation parameter Φ through P, because the barely pruned image sampled from the Markov chain is used only when the weight is updated. The loss function of the transition probability Φ (corresponding to the transition loss in the above embodiment) is shown as following formula:

$${L}_{trans} ( θ , Φ ) = {L}_{task} ( θ , Φ ) + α {L}_{budget} ( Φ ) . \qquad ( 20 )$$

In summary, the pixel pruning process is represented as multiple Markov chains parameterized by the learnable parameters and may be optimized in an end-to-end manner.

In the embodiments of the present disclosure, the redundant pixels of the input image are searched based on the task loss and computation constraints. During differentiable Markov pixel pruning, the pixel pruning process is modeled as multiple Markov chains, and the found redundant pixels may be pruned by simple pruning operations during the inference.

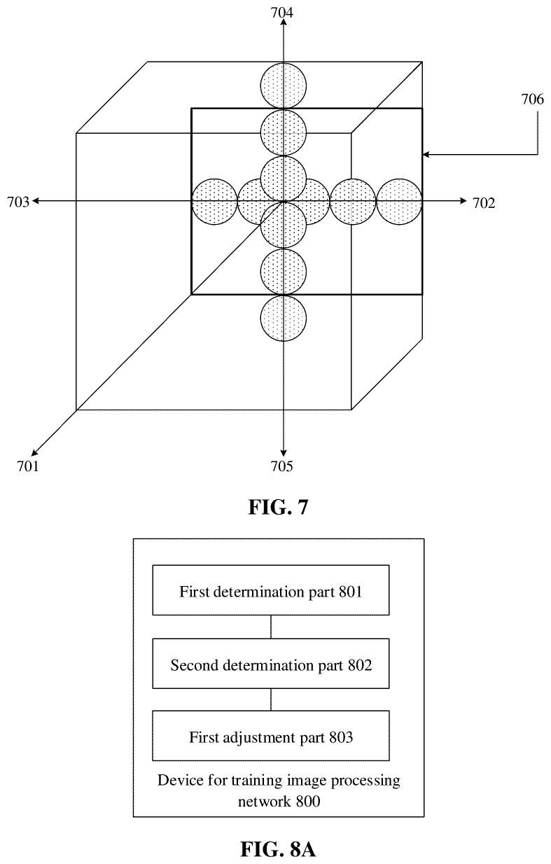

In some embodiments, channel pruning is performed while performing pixel pruning, and a better balance between the use of spatial information and network complexity can be obtained in implementing gaze estimation. As illustrated in FIG. 7, FIG. 7 illustrates a schematic diagram of another application scenario of a method for training a image processing network according to embodiments of the present disclosure. It can be seen from FIG. 7 that for the image processing network having subjected to channel pruning, in the Three-Dimensional (3D) space, channel pruning will be performed on the image processing network based on the Markov chain in the axial direction 701, and pixel cropping will be performed on the image input into the image processing network based on the Markov chains in the axial directions 702, 703, 704, and 705 to obtain a remained area 706. In the embodiments of the present disclosure, the image processing network is trained by combining the channel pruning performed on the network and the pixel cropping performed on the input image, so that the image processing network has a higher accuracy in image cropping, and the efficiency of gaze estimation is improved.

Those skilled in the art may understand that in the above method of detailed description, the order in which the operations are written does not imply a strict order of execution to constitute any limitation on the implementation process, the specific execution sequence of operations may be determined in terms of functions and possible internal logics thereof.

Based on the same invention concept, embodiments of the present disclosure further provide a device corresponding to the method. Since the principle of solving the problem by the device in the embodiments of the present disclosure is similar to the above-mentioned method in the embodiments of the present disclosure, the implementation of the device may refer to the implementation of the method.

Based on the aforementioned embodiments, the embodiments of the disclosure provide a device for training an image processing network. Units included in the device and modules included in each of the units may be implemented by a processor in a computer device, and may of course realized through specific logic circuits. During implementation, the processor may be a Central Processing Unit (CPU), a Microprocessor Unit (MPU), a Digital Signal Processor (DSP), a Field Programmable Gate Array (FPGA), or the like.

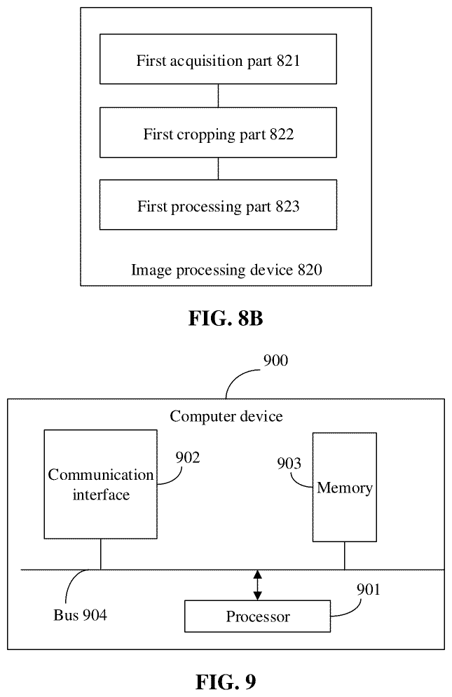

FIG. 8A illustrates a schematic structural diagram of composition of a device for training an image processing network according to embodiments of the present disclosure. As illustrated in FIG. 8A, the device 800 for training an image processing network includes a first determination part 801, a second determination part 802 and a first adjustment part 803.

The first determination part 801 is configured to determine a reference pixel based on a training image annotated with a truth value.

The second determination part 802 is configured to determine, with the reference pixel as a starting point and based on a Markov chain of the training image, cropping probabilities of the image processing network processing the training image.

The first adjustment part 803 is configured to adjust, based on an output result obtained by the image processing network processing a training cropped area and based on the truth value, a network parameter value and the cropping probabilities of the image processing network to obtain a trained image processing network. The training cropped area is obtained by cropping the training image based on the cropping probabilities.

In some embodiments, the training image includes a face image, and the truth value is annotated gaze information in the face image.

In some embodiments, the annotated gaze information includes at least one of: a pitch angle of a gaze, a yaw angle of the gaze, or a roll angle of the gaze.

In some embodiments, the first determination part 801 includes a first determination subpart.

The first determination subpart is configured to determine a center pixel of the training image as the reference pixel.

The second determination part 802 is further configured to: determine, with the center pixel as the starting point and based on the Markov chain, a cropping probability for each pixel in the training image.

In some embodiments, the second determination part 802 includes a second determination subpart and a third determination subpart.

The second determination subpart is configured to determine a transition probability of a next pixel from the center pixel in the Markov chain.

The third determination subpart is configured to determine, based on the transition probability of the next pixel and transition probabilities of multiple pixels prior to the next pixel, a cropping probability of the next pixel.

In some embodiments, the second determination part 802 is further configured to: isotropically set, based on a Markov chain in at least one direction starting from the center pixel, cropping probabilities of all pixels in the at least one direction starting from the center pixel.

In some embodiments, the second determination part 802 is further configured to: set, based on Markov chains along symmetric propagation directions starting from the center pixel, a cropping probability for each pixel along the symmetric propagation directions starting from the center pixel.

In some embodiments, the device further includes a third determination part and a first correction part.

The third determination part is configured to determine, in the training image, a line including a center pixel of the training image.

The first correction part is configured to: correct the training cropped area into an axisymmetric area with the line as a symmetry axis after the training cropped area is obtained by cropping the training image based on the cropping probabilities.

In some embodiments, the device further includes a second correction part.

The second correction part is configured to correct the training cropped area into a centrosymmetric area with the center pixel as a symmetric center after the training cropped area is obtained by cropping the training image based on the cropping probabilities.

In some embodiments, the first adjustment part 803 includes a fourth determination subpart and a first adjustment subpart.

The fourth determination subpart is configured to determine a value of an objective function based on the output result and the truth value.

The first adjustment subpart is configured to, based on the value of the objective function and a computation quantity loss of the image processing network, the network parameter value and the cropping probabilities to obtain the trained image processing network.

In some embodiments, the fifth determination subpart includes a first fusing part, a second fusing part and first comparison part.

The first fusing part is configured to fuse the output result with the truth value to obtain a first fusion result of the training cropped area.

The second fusing part is configured to fuse a result of the image processing network processing the training image with the truth value, to obtain a second fusion result of the training image.

The first comparison part is configured to obtain, based on a ratio of the first fusion result to the second fusion result, the value of the objective function.

In some embodiments, the network parameter value of the image processing network includes: a weight and pruning probabilities of channels to be pruned, and the first adjustment subpart includes a first determination part and a first adjustment part.

The first determination part is configured to obtain a transition loss based on the value of the objective function and the computation loss.

The first adjustment part is configured to adjust, based on the value of the objective function, the weight and the pruning probabilities of the channels to be pruned, and adjust the cropping probabilities based on the transition loss, to obtain the trained image processing network.

Embodiments of the present disclosure provide an image processing device. FIG. 8B illustrates a schematic structural diagram of composition of an image processing device according to embodiments of the present disclosure. As illustrated in FIG. 8B, the image processing device 820 includes a first acquisition part 821, a first cropping part 822 and a first processing part 823.

The first acquisition part 821 is configured to acquire an image to be processed.

The first cropping part 822 is configured to perform, based on cropping probabilities of a trained image processing network, pixel cropping on the image to be processed, to obtain a cropped area to be processed. The trained image processing network is trained based on the above method for training a image processing network.

The first processing part 823 is configured to process the cropped area to be processed by using the trained image processing network, to obtain a processing result for the image to be processed.

In some embodiments, the trained image processing network is used to perform gaze estimation on the image. The first processing module 823 is further configured to perform gaze estimation on the cropped area to be processed by using the trained image processing network, to obtain the processing result for the image to be processed.

The description of the above device embodiment is similar to that of the above method embodiment, and has a beneficial effect similar to that of the method embodiment. In some embodiments, the device provided by the embodiments of the present disclosure have functions or include modules that can be used to perform the method described above in the method embodiments. For technical details not disclosed in the device embodiments of the present disclosure, reference may be made to the description of the method embodiments of the present disclosure.

It should be noted that in the embodiments of the present disclosure, if the method for training the image processing network described above is implemented in form of software function modules and sold or used as an independent product, it can also be stored in a computer-readable storage medium. Based on this understanding, the technical solutions of the embodiments of the present disclosure, in essence or in part contributing to the related technologies, may be embodied in form of a software product stored in a storage medium and includes several instructions for causing a computer device (which may be a personal computer, a server, a network device, etc.) to perform all or part of the methods described in the embodiments of the present disclosure. The aforementioned storage medium includes various media that can store program codes, such as a USB flash disk, a mobile hard disk, a Read Only Memory (ROM), a magnetic disk, or an optical disk. In this way, embodiments of the present disclosure are not limited to any particular hardware, software or firmware, or any combination thereof.

Embodiments of the present disclosure provide a computer device including a memory and a processor. The memory is stored with a computer program executable on the processor. The processor is configured to execute the program to implement part or all of operations of the method above.

Embodiments of the present disclosure provide a computer-readable storage medium having stored thereon a computer program that, when executed by a processor, causes the processor to implement part or all of operations of the method above. The computer-readable storage medium may be transitory or non-transitory.

Embodiments of the present disclosure provide a computer program including computer-readable codes that, when executed by a processor, causes the processor to implement part or all of operations of the method above.

Embodiments of the present disclosure provides a computer program product including a non-transitory computer-readable storage medium storing a computer program that, when read and executed a computer, causes the computer to implement part or all of operations of the method. The computer program product may be implemented by means of hardware, software, or a combination thereof. In some embodiments, the computer program product is embodied as a computer storage medium, and in other embodiments, the computer program product is embodied as a software product, such as a Software Development Kit (SDK).

It should be noted herein that: the above description of the various embodiments tends to emphasize the differences between the various embodiments, and the similarities or likeness thereof may be referred to by each other. The above description of the device, storage medium, computer program, and computer program product embodiments are similar to the above description of the method embodiments, and have beneficial effects similar to the method embodiments. For technical details not disclosed in device, storage media, computer program, and computer program product embodiments of the present disclosure, reference may be made to the description of the method embodiments of the present disclosure.

It is to be noted that FIG. 9 illustrates a schematic diagram of hardware entities of a computer device according to embodiments of the present disclosure. As illustrated in FIG. 9, the hardware entities of the computer device 900 include a processor 901, a communication interface 902, and a memory 903.

The processor 901 generally controls the overall operation of the computer device 900.

The communication interface 902 may enable the computer device to communicate with other terminals or servers through a network.

The memory 903 is configured to store instructions and applications executable by the processor 901, and may also cache data (e.g., image data, audio data, voice communication data, and video communication data) to be processed or already processed by the processor 901 and the modules of the computer device 900, which may be implemented by a FLASH memory or a Random Access Memory (RAM). Data may be transmitted between the processor 901, the communication interface 902, and the memory 903 through the bus 904.

It should be understood that reference throughout the specification to “one embodiment” or “an embodiment” means that a particular feature, structure, or characteristic associated with the embodiment is included in at least one embodiment of the present disclosure. Thus, the appearances of “in one embodiment” or “in an embodiment” in various places throughout the specification do not necessarily refer to the same embodiment. Furthermore, these specific features, structures, or characteristics may be combined in one or more embodiments in any suitable manner. It is to be understood that, in the various embodiments of the present disclosure, the magnitudes of the serial numbers of the operations/processes described above is not meant to mean the order of execution, and the order of execution of the operations/processes should be determined by their functions and intrinsic logics, and should not be construed as any limitation to the implementation of the embodiments of the present disclosure. The serial numbers of the above-described embodiments of the present disclosure are for description only and do not represent the advantages or disadvantages of the embodiments.

It is to be noted that, in this disclosure, the terms “includes”, “including” or any other variation thereof, are intended to cover a non-exclusive inclusion, such that a process, method, article, or device that includes a list of elements includes not only those elements but also other elements not expressly listed, or also includes elements inherent to the process, method, article, or device. Without more limitations, an element limited by the statement “including a . . . ” does not rule out there are additional identical elements in a process, method, article, or apparatus that includes the element.

In several embodiments provided by the present disclosure, it should be understood that the disclosed devices and methods can be realized in other ways. For example, the device embodiment described above are only illustrative. For example, the division of units is only logical function division, and there can be another form of division in actual implementation. For example, multiple units or components may be combined or integrated into another system, or some features can be ignored or not implemented. On the other hand, the mutual coupling or direct coupling or communication connection illustrated or discussed may be indirect coupling or communication connection through some interfaces, devices or units, and may be electric, mechanical or other forms.

The unit described as separation parts may or may not be physically separated, and components displayed as units may or may not be physical units, that is. The units may be located in one place, or may be distributed to multiple network units. Some or all of the units can be selected according to the actual needs to achieve the purpose of the embodiments.

In addition, various functional units in the embodiments of the present disclosure may be integrated in one processing unit, or may exist physically alone respectively, or two or more units may be integrated in one unit. The integrated unit may be implemented in form of hardware or in the form of combination of hardware and software functional units.

It will be appreciated by those of ordinary skill in the art that all or a portion of the operations of the above-described method embodiments may be implemented by means of hardware associated with program instructions. The above-described program may be stored in a computer-readable storage medium. The program, when executed, performs the operations of the above-described method embodiments. The storage medium includes a removable storage device, a Read Only Memory (ROM), a magnetic disk, or an optical disk and other media that can store program codes.

Alternatively, the integrated unit described above may be stored in a computer-readable storage medium if implemented as a software functional module and sold or used as an independent product. Based on such an understanding, the technical solution of the embodiments of the present disclosure, in essence or in part contributing to the related art, may be embodied in the form of a software product, which is stored in a storage medium and includes instructions for making a computer device (which can be a personal computer, a server, a network device, etc.) to perform all or part of the method according to various embodiments of the present disclosure. The aforementioned storage media include various media that can store program code such as a mobile storage device, a ROM, a disk or an optical disk.

The above is only detailed description of the disclosure, but the scope of protection of the disclosure is not limited to this. Any person skilled in the technical field who can easily conceive of modifications or replacement within the technical scope of the disclosure shall be covered in the scope of protection of the disclosure.

### INDUSTRIAL APPLICABILITY

The embodiments of the present disclosure provide a method and device for training an image processing network, and an image processing method and device. The method for training an image processing network includes following. A reference pixel is determined based on a training image annotated with a truth value. With the reference pixel as a starting point and based on a Markov chain of the training image, cropping probabilities of the image processing network processing the training image are determined. A network parameter value and the cropping probabilities of the image processing network are adjusted based on an output result obtained by the image processing network processing a training cropped area and the truth value, to obtain a trained image processing network. The training cropped area is obtained by cropping the training image based on the cropping probabilities.

1. A method for training an image processing network, performed by an electronic device and comprising:
determining a reference pixel based on a training image annotated with a truth value;
determining, with the reference pixel as a starting point and based on a Markov chain of the training image, cropping probabilities of the image processing network processing the training image; and
adjusting, based on an output result obtained by the image processing network processing a training cropped area and based on the truth value, a network parameter value and the cropping probabilities of the image processing network to obtain a trained image processing network, wherein the training cropped area is obtained by cropping the training image based on the cropping probabilities.

2. The method of claim 1, wherein the training image comprises a face image, and the truth value is annotated gaze information in the face image.

3. The method of claim 2, wherein the annotated gaze information comprises at least one of:
a pitch angle of a gaze,
a yaw angle of the gaze, or
a roll angle of the gaze.

4. The method of claim 2, wherein determining the reference pixel based on the training image annotated with the truth value comprises:
determining a center pixel of the training image as the reference pixel; and
wherein determining, with the reference pixel as the starting point and based on the Markov chain of the training image, the cropping probabilities of the image processing network processing the training image comprises:
determining, with the center pixel as the starting point and based on the Markov chain, a cropping probability for each pixel in the training image.

5. The method of claim 4, wherein determining, with the center pixel as the starting point and based on the Markov chain, the cropping probability for each pixel in the training image comprises:
determining a transition probability of a next pixel from the center pixel in the Markov chain; and
determining, based on the transition probability of the next pixel and transition probabilities of a plurality of pixels prior to the next pixel, a cropping probability for the next pixel.

6. The method of claim 4, wherein determining, with the center pixel as the starting point and based on the Markov chain, the cropping probability for each pixel in the training image comprises:
isotropically setting, based on a Markov chain in at least one direction starting from the center pixel, cropping probabilities of all pixels in the at least one direction starting from the center pixel.

7. The method of claim 4, wherein determining, with the center pixel as the starting point and based on the Markov chain, the cropping probability for each pixel in the training image comprises:
setting, based on Markov chains along symmetric propagation directions starting from the center pixel, a cropping probability for each pixel along the symmetric propagation directions starting from the center pixel.

8. The method of claim 1, wherein after the training cropped area is obtained by cropping the training image based on the cropping probabilities, the method further comprises:
determining, in the training image, a line comprising a center pixel of the training image; and
correcting the training cropped area into an axisymmetric area with the line as a symmetry axis.

9. The method of claim 1, wherein after the training cropped area is obtained by cropping the training image based on the cropping probabilities, the method further comprises:
correcting the training cropped area into a centrosymmetric area with the center pixel as a symmetric center.

10. The method of claim 1, wherein adjusting, based on the output result obtained by the image processing network processing the training cropped area and based on the truth value, the network parameter value and the cropping probabilities of the image processing network to obtain the trained image processing network comprises:
determining a value of an objective function based on the output result and the truth value; and
adjusting, based on the value of the objective function and a computation quantity loss of the image processing network, the network parameter value and the cropping probabilities to obtain the trained image processing network.

11. The method of claim 10, wherein determining the value of the objective function based on the output result and the truth value comprises:
fusing the output result with the truth value to obtain a first fusion result of the training cropped area;
fusing a result of the image processing network processing the training image with the truth value, to obtain a second fusion result of the training image; and
obtaining, based on a ratio of the first fusion result to the second fusion result, the value of the objective function.

12. The method of claim 10, wherein the network parameter value of the image processing network comprises: a weight and a pruning probability of a channel to be pruned, and adjusting, based on the value of the objective function and the computation quantity loss of the image processing network, the network parameter value and the cropping probabilities to obtain the trained image processing network comprises:
obtaining a transition loss based on the value of the objective function and the computation quantity loss; and
adjusting, based on the value of the objective function, the weight and the pruning probability of the channel to be pruned, and adjusting the cropping probabilities based on the transition loss to obtain the trained image processing network.

13. An image processing method, comprising:
acquiring an image to be processed;
performing, based on cropping probabilities of a trained image processing network, pixel cropping on the image to be processed, to obtain a cropped area to be processed, wherein the trained image processing network is trained based on the method of claim 1; and
processing the cropped area to be processed by using the trained image processing network, to obtain a processing result for the image to be processed.

14. The method of claim 13, wherein the trained image processing network is used for performing gaze estimation on an image, and processing the cropped area to be processed by using the trained image processing network, to obtain the processing result for the image to be processed comprises:
performing gaze estimation on the cropped area to be processed by using the trained image processing network, to obtain the processing result for the image to be processed.

15. A device for training an image processing network, comprising a memory and a processor, wherein the memory is stored with a computer program executable on the processor, and the processor is configured to execute the computer program to:
determine a reference pixel based on a training image annotated with a truth value;
determine, with the reference pixel as a starting point and based on a Markov chain of the training image, cropping probabilities of the image processing network processing the training image; and
adjust, based on an output result obtained by the image processing network processing a training cropped area and based on the truth value, a network parameter value and the cropping probabilities of the image processing network to obtain a trained image processing network, wherein the training cropped area is obtained by cropping the training image based on the cropping probabilities.

16. The device of claim 15, wherein the training image comprises a face image, and the truth value is annotated gaze information in the face image.

17. The device of claim 15, wherein in adjusting, based on the output result obtained by the image processing network processing the training cropped area and based on the truth value, the network parameter value and the cropping probabilities of the image processing network to obtain the trained image processing network, the processor is configured to execute the computer program to:
determine a value of an objective function based on the output result and the truth value; and
adjust, based on the value of the objective function and a computation quantity loss of the image processing network, the network parameter value and the cropping probabilities to obtain the trained image processing network.

18. An image processing device, comprising a memory and a processor, wherein the memory is stored with a computer program executable on the processor, and the processor is configured to execute the computer program to:
acquire an image to be processed;
perform, based on cropping probabilities of a trained image processing network, pixel cropping on the image to be processed, to obtain a cropped area to be processed, wherein the trained image processing network is trained based on the method of claim 1; and
process the cropped area to be processed by using the trained image processing network, to obtain a processing result for the image to be processed.

19. A non-transitory computer-readable storage medium having stored thereon a computer program that, when executed by a processor, causes the processor to implement a method for training an image processing network, the method comprising:
determining a reference pixel based on a training image annotated with a truth value;
determining, with the reference pixel as a starting point and based on a Markov chain of the training image, cropping probabilities of the image processing network processing the training image; and
adjusting, based on an output result obtained by the image processing network processing a training cropped area and based on the truth value, a network parameter value and the cropping probabilities of the image processing network to obtain a trained image processing network, wherein the training cropped area is obtained by cropping the training image based on the cropping probabilities.

20. A non-transitory computer-readable storage medium having stored thereon a computer program that, when executed by a processor, causes the processor to perform the steps of the method of claim 13.
